(19) United States
(12) Patent Application Publication
(10) Pub. No.: US 2015/0312270 A1
(43) Pub. Date: Oct. 29, 2015

(54) SECURITY CONTROLS

(71) Applicants: Richard THRELKELD, Boca Raton, FL (US); Ripal VAIDYA, London (GB); Osama AL-HASSANI, London (GB)

(72) Inventors: Richard THRELKELD, Boca Raton, FL (US); Ripal VAIDYA, London (GB); Osama AL-HASSANI, London (GB)

(73) Assignee: 1E LIMITED, London (GB)

(21) Appl. No.: 14/265,287

(22) Filed: Apr. 29, 2014

(51) Int. Cl. H04L 29/06

(52) U.S. Cl. CPC H04L 63/1433; H04L 63/1408

(57) ABSTRACT

A network of computers has a network management system which stores metadata comprising at least the identities of software present on computers of the network. A computer of the network runs a monitoring program which accesses the metadata stored in the network management system to provide a measure of the extent to which one or more of a plurality of security controls are implemented in the network. The security controls are the application of Operating System patches, the application of third party software patches, allowing only applications on a list of approved software to run, and limiting administrator privileges. The measure comprises risk ratings dependent on the extents to which the controls are implemented.

### BACKGROUND OF THE INVENTION

1. Field of the Invention

The present application relates to monitoring one or more computer networks.

2. Description of the Related Technology

It is known to perform bench marking to ensure computer systems are secure. The US government, the Australian Government and Microsoft consider that 4 security controls mitigate against 85% of software intrusions. The security controls are

1) apply Operating System patches;

2) apply third party software patches;

3) allow only applications on a “white list” (i.e. a list of approved software), to run; and

4) limit administrator privileges.

A network of computers may have tens, or even hundreds or more, of computers and each computer may have a large number of programs installed on it. Also many users may have administrator rights granted for their computer. Some users may install software on their computers independently of the network management system. Also computers, for example laptop computers join and leave the network at random. To manually apply the key controls to an existing network is a difficult if not impossible task. There is a need to provide software tools for determining how well the controls are applied to computers in a network.

### SUMMARY

According to one embodiment of the invention, there is provided a method of monitoring a network of computers, the network having a network management system which stores metadata and other data relating to software present on computers of the network, the method comprising running on a computer of the network a monitoring program which accesses the metadata and other data stored in the network management system to provide a measure of the extent to which one or more of a plurality of security controls are implemented in the network, wherein the security controls are: 1) application of Operating System patches; 2) application of third party software patches; 3) allowing only applications on a list of approved software to run; and 4) limiting administrator privileges; and the measure comprises risk ratings dependent on the extents to which the controls are implemented.

An example of the method further comprises providing a measure of the extent to which one or more of a plurality of security controls are implemented in another network, wherein the security controls are: 1) application of Operating System patches; 2) application of third party software patches; 3) allowing only applications on a list of approved software to run, and 4) limiting administrator privileges, and the measure comprises risk ratings dependent on the extents to which the controls are implemented; and comparing the risk ratings of the first-mentioned network with risk ratings of the another network.

Another aspect of the invention provides a monitoring program which when run on a computer in a network of computers, the network having a network management system which stores metadata and other data relating to software present on computers of the network, accesses the metadata and other data stored in the network management system to provide a measure of the extent to which one or more of a plurality of security controls are implemented in the network, wherein the security controls are: 1) application of Operating System patches; 2) application of third party software patches; 3) allowing only applications on a list of approved software to run; and 4) limiting administrator privileges; and the measure comprises risk ratings dependent on the extents to which the controls are implemented.

Further features and advantages of the invention will become apparent from the following description of illustrative embodiments of the invention, given by way of example only, which is made with reference to the accompanying drawings.

### BRIEF DESCRIPTION OF THE DRAWINGS

FIG. 1 is a schematic diagram of a physical computer network;

FIG. 2 is a schematic diagram of a computer of the network of FIG. 1;

FIG. 3 is a flow chart of an illustrative method of comparing and rating plural domains and collecting metadata according to one or more embodiments of the invention;

FIG. 4 is a flow chart of an illustrative method of determining the risk of running an application according to one or more embodiments of the invention;

FIG. 5 is a flow chart of an illustrative method of obtaining metadata of software run on the domain according to one or more embodiments of the invention;

FIG. 6 illustrates a method of rating a domain on the basis of updates of Operating Systems according to one or more embodiments of the invention;

FIG. 7 illustrates a method of rating a domain on the basis of updates of applications according to one or more embodiments of the invention; and

FIG. 8 illustrates a method of rating a domain on the basis of administration rights according to one or more embodiments of the invention.

### DETAILED DESCRIPTION OF CERTAIN INVENTIVE EMBODIMENTS

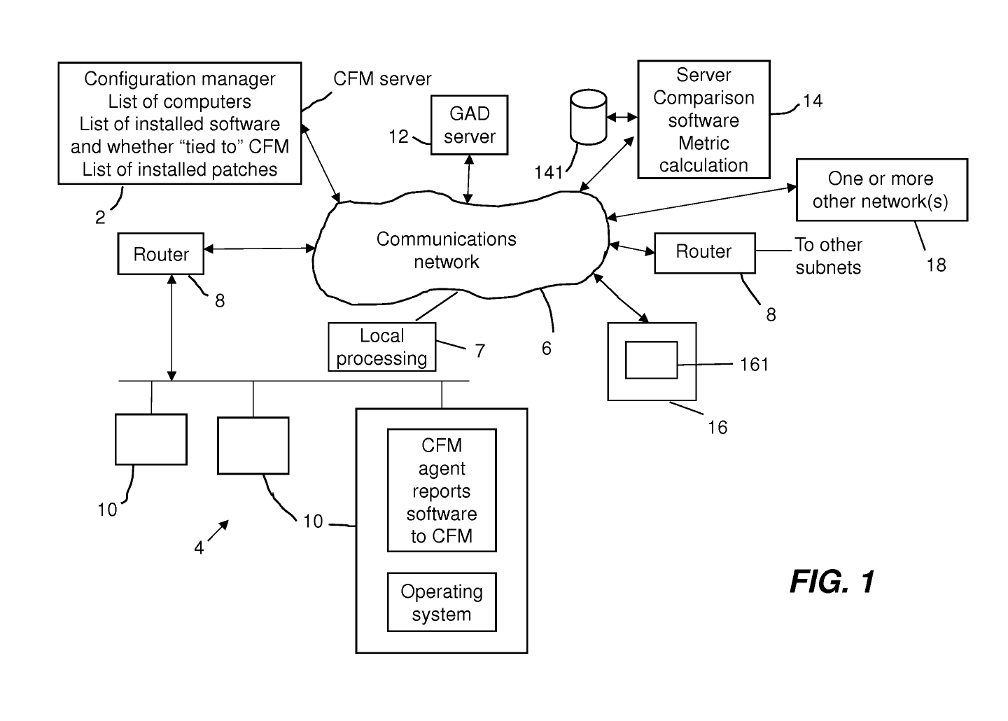

FIG. 1 illustrates an example of a network in which the present invention may be used, but those skilled in the art will appreciate the invention may be used in other networks.

The network of FIG. 1 comprises a network management system, in this example a Microsoft Configuration Manager (CFM) 2 coupled to one or more sub-networks or network branches 4 by a communications network 6 via one or more routers 8. Each sub-network 4 comprises one or more computers 10. Other examples of network management systems are available from other companies. The computers 10 may be of different types for example desk top computers, laptops amongst others. Portable computers such as laptops may be connected to the network only temporarily.

Each computer 10 has at least an operating system, applications software and a CFM agent. Administrator rights are set in the operating system. The CFM agent communicates with the CFM 2 informing the CFM 2 in known manner of software installed on the computer. Software may be installed on a computer 10 using the network management system, for example using Microsoft Installer. Software may also be installed on a computer 10 by the user if the user has administrator rights which allow that. The Configuration Manager CFM 2 stores data relating to the computers 10 and the software installed on them including data identifying the computers, data identifying the software, including patches, installed on them, and other data as will be described in more detail below.

The network of FIG. 1 also includes a computer, e.g. a server, 12 on which is a Global Active Directory (GAD) and a computer 7, which may be server, for carrying out local processing of network data as will be described below. Computer 7 is referred to herein as a local processor.

The network of FIG. 1 is connected via the communications network 6 to a computer 14, for example a server referred herein as a third party computer because it may be operated by an organisation independent of the owners of the domain of FIG. 1. The network of FIG. 1 is in a domain. The server 14 may be outside the domain. In this example, the communications network 6 is connected to one or more other networks which are in domains and the third party computer 14 communicates with the other networks but be outside the domains. The computer 14 carries out processing of data from plural networks as will be described below. Each network may be as shown in FIG. 1.

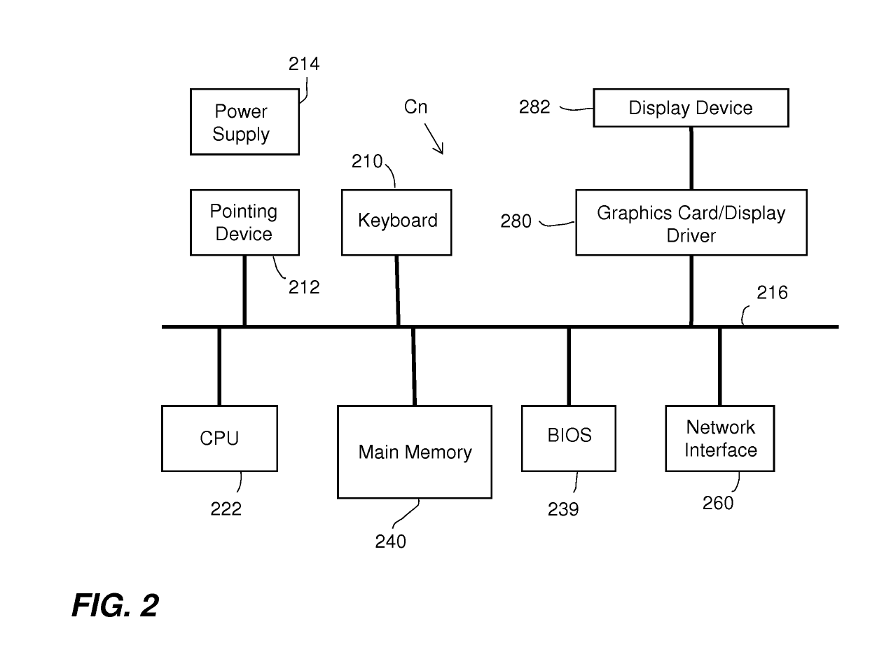

Referring to FIG. 2, an illustrative one of the computers 2, 10, 12, 14 and 16 comprises, amongst other items: a CPU 222; a main memory 240 for example a hard disk drive or other storage device, for example electronic memory; a network interface 260, a BIOS 239 and one or more busses 216. The BIOS 239 is typically a Read Only Memory (ROM). The computers may also have other items for example a display driver 280 coupled to a display device 282; human interface devices or input devices for example a keyboard 210 and a pointing device 212. The items are conventional and interact via the bus(es) 216 in a conventional way. The network interface couples the computer to the communications network 6 via the routers 10 and to other computers in the sub-network 4 having respective IP (Internet Protocol) addresses. The computer also comprises a power supply 214. Programs are stored in the main memory 240 and executed by the CPU 222.

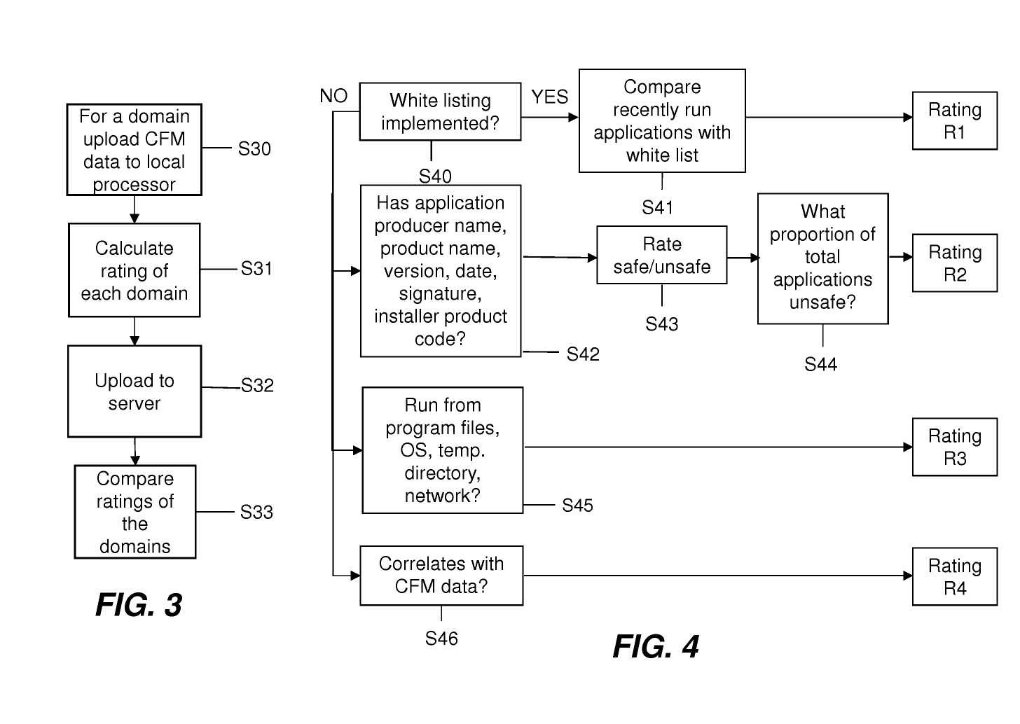

### FIG. 3

### Overview

Steps S30, S31 and S32 of FIG. 3 are carried out by the local processor 7 of the or each network. Comparison step S33 is carried out by the processor 14 connected to plural networks. The CFM 2, together with the CFM agents, of the, or each, domain gathers and stores data relating to all the software on the domain. As indicated at S30, the CFM data of a network is uploaded to the local processor 7 of that network. At step S31, the local processor 7 calculates for each domain an overall rating which indicates how well the domain implements the aforementioned four security controls

1) application of Operating System patches;

2) application of third party software patches;

3) allowing only applications on a “white list” (i.e. a list of approved software), to run; and

4) limiting administrator privileges;

and other desirable security controls as will be described by way of example with reference to FIGS. 4 to 8.

The overall rating of a domain is based on a combination of individual ratings of the four security controls as will be described with reference to FIGS. 4 to 8.

The steps S30 and S31 may be repeated regularly or continuously.

### FIG. 4

### Determining the Risk of Running an Application

Firstly, an operator manually indicates to the risk determination program of FIG. 4 at step S40 whether white listing is implemented in a domain. If yes, the identities of applications recently run in the domain are compared with the white list of that domain and a rating R1 produced representing the ratio of the number of different applications run to the number of applications on the white list. “Recently” means within a time interval selectable by an operator for example within the last 31, 60 or 90 days or any other time interval chosen by an operator.

If white listing is not implemented, a risk analysis is carried out as follows.

In step S42, one or more of the following tests are applied to each software item run; has the software a)i) a producer name, a)ii) a product name, a)iii) a version name and a)iv) a date, (in all four cases i) to iv) established at compile time).

Other tests which may additionally or alternatively be applied are b)i) has the software a signature applied by a certification authority, and/or b)ii) does it have a product code applied by the installer program of the CFM 2? Based on those tests the software is rated safe or unsafe at step S43. Step S44 then calculates the proportion of the total number of different applications in the domain which are unsafe to produce a rating R2.

Step S45 tests where is the software running from? For example it may run from c)i) the program files memory (main memory) of a computer 10 which is desirable or c)ii) from a user temp directory or c)iii) from the network both of which are undesirable. Step S45 produces a rating R3.

A risk metric may be calculated combining ratings R1 to R3. The metric applies to each of the criteria of a) to c) a confidence factor which may be weighted. For example the metric M may be

M=w1a)i)+w2a)ii)+w3a)iii)+w4a)iv)+w5b)i)−w6b)ii+w7c)i)−w8c)ii−w8c)iii)

Where w1 to w8 are weighting factors, which could be one, and a)i) to c)iii) are confidence values relating to the like numbered criteria set out above. In this example, the greater the metric, the lower the risk of running the software.

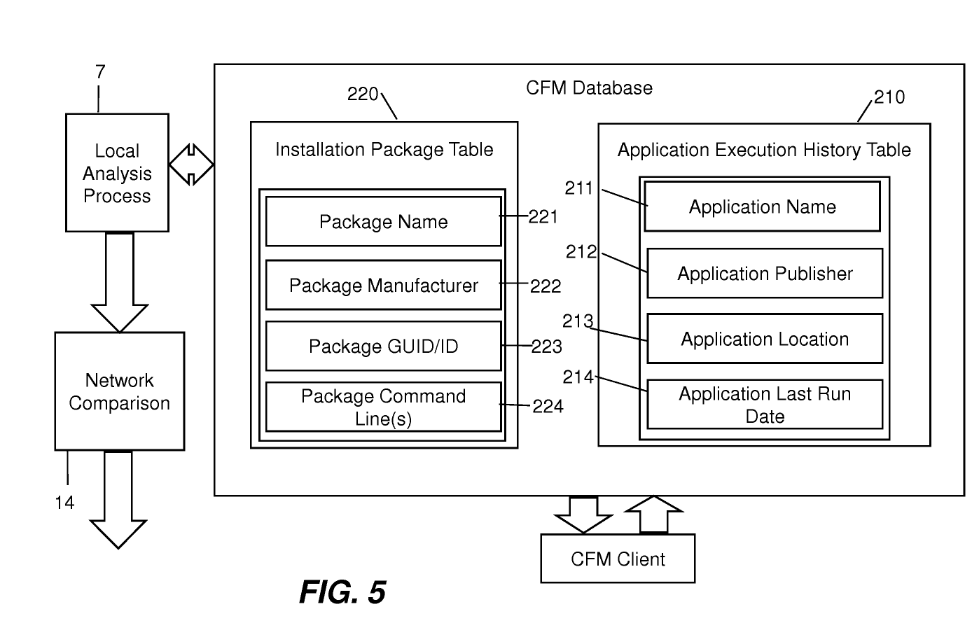

Step S46 determines if the metadata of an item of software running in the domain correlates with data in the CFM2. How this may be done is discussed with reference to FIG. 5. It produces a rating R5 which is combined with ratings R1 to R4 to produce an overall white listing risk rating for the domain

### FIG. 5

The CFM database 21 has an application execution history table containing the execution history 210 for different Applications that have run on client systems. This history is created automatically and is part of the standard inventory process. The database holds the metadata for each system and its Application launch history such as the Name and Version 211, and Publisher 212 which it reads from the binary data of the Application. Additionally this contains the location 213 on the client system that the Application was run from and the date/time 214 this took place.

The CFM database also has an installation package table 220. The installation package table 220 stores data relating to ‘packages’ used for installing software on domain systems. Administrative staff create these Packages over time. The database holds metadata for each package such as the Name 221, Manufacturer 222, version, GUID (unique identifier) 223 and command lines 224 for installing or uninstalling the software.

The software for determining whether an application is tied to the CFM compares the fields from the two package tables of the database and assigns confidence levels (low, medium and high) on the number of matches from fields in the Application and fields in all the Packages. If all fields match exactly there is high confidence, if only a couple match there is medium confidence and no matches means low confidence.

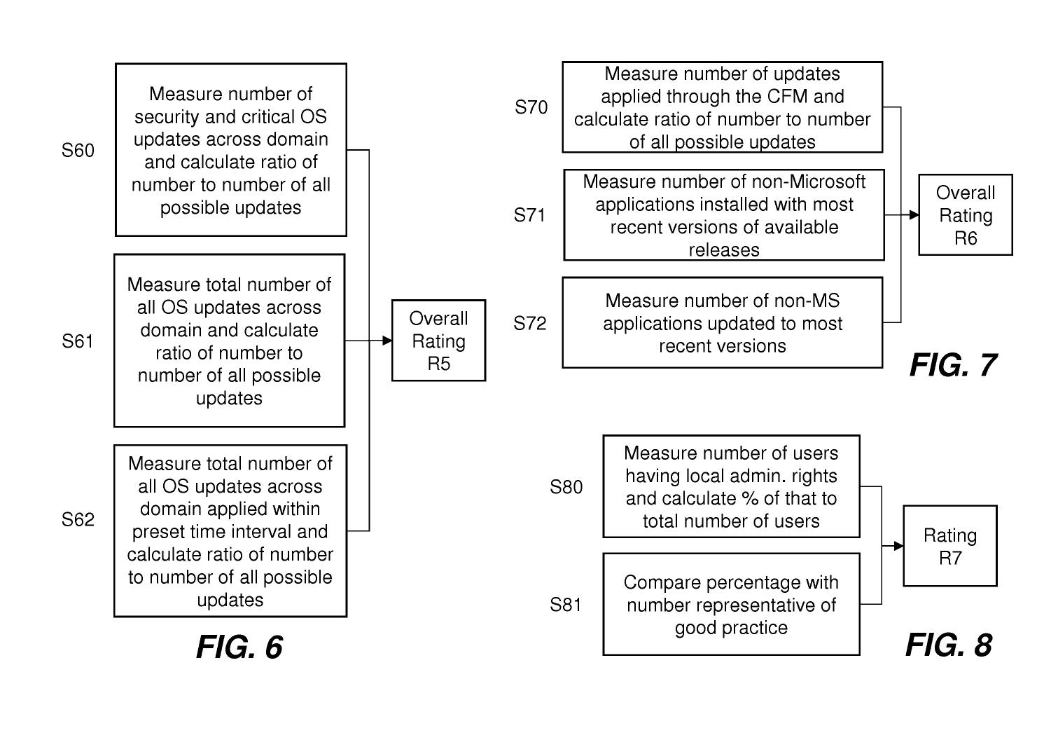

### FIG. 6

### Rating a Domain on the Basis of Updates of Operating Systems (OS)

This uses the uploaded CFM data of a domain to Measure S60 the number of security and critical OS updates across domain and calculate the ratio of that number to the total number of possible critical updates across the domain

Measure S61 total number of all OS updates across domain and calculate the ratio of that number to the total number of possible OS updates across the domain; and

Measure S62 total number of all OS updates across domain applied within preset time interval from the availability of the update and calculate the ratio of number to the total number of possible updates within the interval across the domain.

An overall rating R5 is produced based on the calculated ratios.

### FIG. 7

### Rating a Domain on the Basis of Updates of Applications

This uses the uploaded CFM data of a domain to measure S70 the number of updates applied through the CFM and calculate ratio of number to the total number of possible such updates across the domain;

measure S71 the number of non-Microsoft applications (if the domain uses Microsoft programs) installed with most recent versions of available releases; and

measure S72 the number of non-Microsoft applications updated to most recent versions.

An overall rating R6 is produced. It will be appreciated that the reference to Microsoft applications is by way of example only and could be replaced by reference to another well-known and trusted supplier of software.

### FIG. 8

### Admin Rights

Data relating to administration rights is entered into the CFM automatically by software in known manner. The administration rights data in the CFM of a domain is used to measure S80 the number of users having local admin rights and calculate the percentage of that to total number of users. Step S81 compares that percentage with a number representative of good practice in the industry. An overall rating R7 is produced.

### Overall Rating

An overall domain rating may be produced by combining the overall ratings R1 to R7. The combination of ratings may weight the ratings R1 to R7.

### Dashboard

The ratings R1 to R7 may be displayed on a dashboard 161 on for example a manager's workstation 16 on the network of FIG. 1.

### Comparison of Plural Networks

The processes of FIGS. 4 to 8 as described above are carried out in a single network or domain giving a rating for that domain. The processes of FIGS. 4 to 8 may be carried out in plural different networks 4 and 18 or domains of FIG. 1. As shown in FIG. 3 at step S32, the ratings of all the networks may be uploaded to the server 14 and compared at step S33. Such a comparison gives the network managers information about how well the networks are performing in comparison with other networks. The steps S30 to S33 may be carried out regularly or continuously.

### Programs

Examples as described herein may be implemented by a suite of computer programs which when run on one or more computer devices of the network. For example, a computer program run on a server computer device may implement the method of FIG. 3, 4 or 5. This provides an efficient technical implementation that is easy to reconfigure; however, other implementations may comprise a hardware-only solution or a mixture of hardware devices and computer programs. For example, some server computer devices may have bespoke hardware modules for reporting usage data. In one case, different entities may provide different aspects of the examples; for example, the identification and usage process may be implemented by an entity different to that which manages the network and/or provides the systems management tool. Likewise, monitoring of the usage of software on one or more computer devices and/or the gathering of data relating to use of functions is typically performed by one or more computer programs implemented on one or more computer devices that communicate over the network 6 with other computer programs on other computer devices. One or more computer programs that are supplied to implement the invention may be stored on one or more carriers, which may also be non-transitory. Examples of non-transitory carriers include a computer readable medium for example a hard disk, solid state main memory of a computer, an optical disc, a magneto-optical disk, a compact disc, a magnetic tape, electronic memory including Flash memory, ROM RAM, a RAID or any other suitable computer readable storage device.

The term “software” as used herein refers to any tool, function or program that is implemented by way of computer program code. In use, an executable form of the computer program code is loaded into memory (e.g. RAM) and is processed by one or more processors. As such the term “software” includes, without limitation:—an operating system; application programs; patches for, and updates of, software already installed on the network; and new software packages.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of monitoring a network of computers, the network having a network management system which stores metadata and other data relating to software run on computers of the network, the method comprising:
running on a computer of the network a monitoring program which accesses the metadata and other data stored in the network management system to provide a measure of the extent to which one or more of a plurality of security controls are implemented in the network, wherein the security controls include:
application of Operating System patches;
application of third party software patches;
allowing only applications on a list of approved software to run; and
limiting administrator privileges; and
wherein the measure comprises risk ratings dependent on the extents to which the controls are implemented.

2. The method of claim 1, wherein a user of the monitoring program indicates whether or not the security control relating to allowing only software on a list of approved software to run is implemented and applying a risk rating dependent on whether or not that security control is not implemented.

3. The method of claim 1, wherein if the security control relating to allowing only applications on a list of approved software to run is not implemented, the program analyses a plurality of risk criteria relating to items of software running on the network and applies risk ratings dependent on those criteria.

4. The method of claim 3, wherein for an item of software running on the network, the criteria include whether the item of software has one or more of a compile time populated producer name, product name, version name and date, and a risk rating is applied to the item of software accordingly.

5. The method of claim 4, wherein criteria include whether the software has a software identification code associated with an installation system.

6. The method of claim 4, wherein criteria include whether the software has a security certificate.

7. The method of claim 4, wherein the risk determination program calculates a risk metric dependent on the risk criteria.

8. The method of claim 7, wherein the risk metric is a weighted sum of confidence values associated with the respective criteria.

9. The method of claim 4, wherein a risk rating is applied to the network dependent on the proportion of all software items on the network are deemed safe according to the risk ratings of the individual items of software.

10. The method of claim 3, wherein criteria include the identity of where the software runs from.

11. The method of claim 3, wherein the criteria include whether metadata of software running on the network correlates with metadata in the network management system.

12. The method of claim 1, wherein a measure of the extent to which the application of software patches is determined according to one or more of a measure of the number of updates applied to software through the network management system;
a measure of the total number of software items installed with the most recent versions; and
a measure of the number of software items updated to the most recent versions.

13. The method of claim 1, wherein a measure of the extent to which the application of operating system patches is determined according to one or more of
a measure of the number of security and critical operating system updates applied across the network;
a measure of the number of all operating system updates applied across the network; and
a measure of the number of operating system updates applied across the network within a preset time of the updates being available.

14. The method of claim 1, wherein a measure of the extent to which the limitation of administrator privileges is determined according to the percentage of all users having local administrative rights.

15. The method of claim 14 wherein that percentage is compared to a preset number representing good practice.

16. The method of claim 1, further comprising providing a measure of the extent to which one or more of a plurality of security controls are implemented in another network, wherein the security controls are application of Operating System patches;
application of third party software patches;
allowing only applications on a list of approved software to run; and
limiting administrator privileges; and
the measure comprises risk ratings dependent on the extents to which the controls are implemented; and
comparing the risk ratings of the first-mentioned network with risk ratings of the another network.

17. A non-transitory computer-readable medium comprising computer-executable instructions which, when executed by a processor, cause a computing device to perform a method for monitoring on a network of computers the network having a network management system which stores metadata and other data relating to software present on computers of the network, the method comprising:
accessing the metadata and other data stored in the network management system to provide a measure of the extent to which one or more of a plurality of security controls are implemented in the network, wherein the security controls include:
application of Operating System patches;
application of third party software patches;
allowing only applications on a list of approved software to run; and
limiting administrator privileges; and
wherein the measure comprises risk ratings dependent on the extents to which the controls are implemented.
